(19) United States
(12) Patent Application Publication
(10) Pub. No.: US 2022/0193931 A1
(43) Pub. Date: Jun. 23, 2022

(54) Robot Arm And Robot

(71) Applicant: Seiko Epson Corporation, Tokyo (JP)

(72) Inventors: Yuta ICHIMIYA, Matsumoto (JP); Hidenori HAMA, Shiojiri (JP); Shingo HOSHINO, Hokuto (JP)

(21) Appl. No.: 17/552,381

(22) Filed: Dec. 16, 2021

(30) Foreign Application Priority Data
Dec. 17, 2020 (JP) 2020-209034

(51) Int. Cl. B25J 18/04; B25J 9/10; B25J 9/12; B25J 9/00

(52) U.S. Cl. CPC B25J 18/04; B25J 9/0009; B25J 9/126; B25J 9/1025

(57) ABSTRACT

A robot arm includes a first arm having a housing with a first stopper provided therein, a second arm rotating relative to the first arm, and a joint unit including an outer ring portion fixed to the second arm, a second stopper provided in the outer ring portion and restricting rotation of the second arm relative to the first arm in cooperation with the first stopper, and an inner ring portion fixed to the first arm and rotating coaxially with the outer ring portion, wherein the housing has a first opening portion opening toward the outer ring portion in a position facing the outer ring portion, and the first stopper projects from the first opening portion.

The present application is based on, and claims priority from JP Application Serial Number 2020-209034, filed Dec. 17, 2020, the disclosure of which is hereby incorporated by reference herein in its entirety.

### BACKGROUND

### 1. Technical Field

The present disclosure relates to a robot arm and a robot.

### 2. Related Art

Robots including joint units between arms are widely used. The joint unit includes a motor and a reducer. International Publication 2018/055752 discloses a joint unit that restricts a rotation angle. According to the publication, the joint unit includes a ring-shaped bearing. Restriction bolts are placed for a frame fixed to an inner ring of the bearing and an outer ring. When the bearing rotates to a limitation of rotation, the respective restriction bolts interfere to restrict the rotation angle of the bearing. The frame has a plurality of holes. In the restriction structure for the rotation angle, the restriction bolts are inserted into the holes and the restriction bolts are fastened by nuts. When the rotation angle of the bearing is changed, an operator detaches the restriction bolts from the frame and reinserts the restriction bolts into other holes.

However, in International Publication 2018/055752, for detachment of the restriction bolts from the frame, it is necessary to disassemble the bearing, the frame, and the reducer fastened by the bolts and there is a problem that changing of the positions of the restriction bolts and replacement of the restriction bolts are not easy.

### SUMMARY

A robot arm includes a first member having a housing with a first stopper provided therein, a second member rotating relative to the first member, and a joint unit including an outer ring portion fixed to the second member, a second stopper provided in the outer ring portion and restricting rotation of the second member relative to the first member in cooperation with the first stopper, and an inner ring portion fixed to the first member and rotating coaxially with the outer ring portion, wherein the housing has a first opening portion opening toward the outer ring portion in a position facing the outer ring portion, and the first stopper projects from the first opening portion.

A robot includes the above described robot arm.

### BRIEF DESCRIPTION OF THE DRAWINGS

FIG. 1 is a schematic side sectional view showing a configuration of a robot according to a first embodiment.

FIG. 2 is a schematic view showing a configuration of a joint unit.

FIG. 3 is a schematic diagram for explanation of placement of stoppers.

FIG. 4 is a schematic diagram for explanation of operation of the stoppers.

FIG. 5 is a schematic diagram for explanation of the operation of the stoppers.

FIG. 6 is a schematic side sectional view showing a configuration of a stopper according to a second embodiment.

FIG. 7 is a schematic diagram for explanation of placement of a buffer portion.

FIG. 8 is a schematic side sectional view showing a configuration of a joint unit according to a third embodiment.

FIG. 9 is a schematic side sectional view showing a configuration of a joint unit according to a fourth embodiment.

### DESCRIPTION OF EXEMPLARY EMBODIMENTS

As below, an embodiment will be explained with reference to the drawings. Note that the respective members in the respective drawings are shown in various scales with respect to each member in sizes recognizable in the respective drawings.

### First Embodiment

In the embodiment, a characteristic example of a robot will be explained with reference to the drawings.

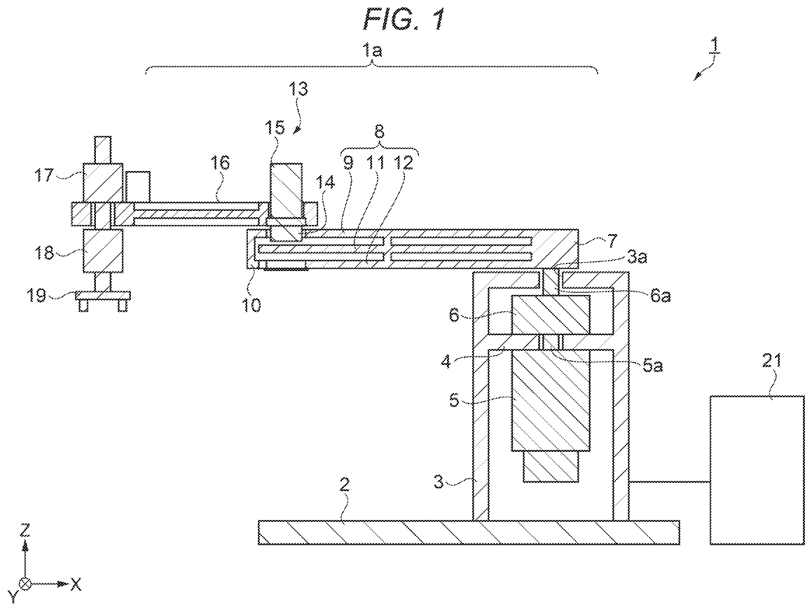

As shown in FIG. 1, a robot 1 includes a base 2 formed in a flat plate shape. One direction on the horizontal surface of the base 2 is referred to as “X direction”. A direction opposite to the direction of gravity force is referred to as “Z direction” and a direction orthogonal to the X direction and the Z direction is referred to as “Y direction”.

A support 3 is placed on the base 2. A hollow space is formed inside of the support 3 and the hollow space is divided in upper and lower parts by a supporting board 4. A first motor 5 is placed at the downside of the supporting board 4.

A first reducer 6 is placed at the upside of the supporting board 4, and a rotation shaft 5a of the first motor 5 is coupled to an input shaft of the first reducer 6. An output shaft 6a of the first reducer 6 is placed at the upside of the first reducer 6. The output shaft 6a rotates at a rotation speed reduced from the rotation speed of the rotation shaft 5a of the first motor 5. A wave gearing is used for the first reducer 6. The wave gearing is also referred to as “harmonic drive (registered trademark)”. A hole portion 3a is formed in the upper surface of the support 3 and the output shaft 6a is placed to project from the hole portion 3a.

A first arm 7 as a first member in a substantially rectangular parallelepiped shape is placed to be coupled to the output shaft 6a and the first arm 7 is rotated around the output shaft 6a. The first motor 5 rotates, and thereby, the first arm 7 is rotated.

The first arm 7 has a housing 8. The housing 8 includes an upper plate 9, a middle plate 11, and a lower plate 12. There are spaces between the upper plate 9 and the middle plate 11. There are spaces between the middle plate 11 and the lower plate 12. The housing 8 has a light weight because of the spaces. As described above, the housing 8 has the middle plate 11 inside.

A joint unit 13 is placed on the first arm 7 at an end opposite to the first motor 5. The joint unit 13 includes a second reducer 14 as a reducer and a wave gearing and a second motor 15 as a motor. The second reducer 14 is a wave gearing. The output shaft of the second reducer 14 rotates at a rotation speed reduced from the rotation speed of the rotation shaft of the second motor 15. Direct-current motors are used for the first motor 5 and the second motor 15.

The housing 8 includes a window portion 10 as a cover at an end at the negative side in the X direction. The window portion 10 as a part of the housing 8 is transparent. An operator may observe the inside of the housing 8 through the window portion 10.

A second arm 16 as a second member is placed to be coupled to the joint unit 13. A robot arm 1a includes the first arm 7, the joint unit 13, the second arm 16, etc. The second arm 16 is rotated relative to the first arm 7 by the second reducer 14. The second arm 16 rotates relative to the first arm 7. An elevation device 17 is placed on the second arm 16 at an end opposite to the second motor 15. The elevation device 17 includes a linear motion mechanism and expands and contracts by driving of the linear motion mechanism.

According to the configuration, the second reducer is the wave gearing and the joint unit 13 may have the light weight. Further, the reduction ratio of the second reducer 14 is higher, and thereby, a relative angle between the first arm 7 and the second arm 16 may be controlled with higher position accuracy.

A rotating device 18 is placed at the downside of the elevation device 17. The rotating device 18 includes a step motor. An actuator 19 is placed at the downside of the rotating device 18. The actuator 19 moves upward and downward by the elevation device 17. Further, the actuator 19 rotates by the rotating device 18.

A controller 21 is placed at the positive side in the X direction of the support 3. The controller 21 controls the first motor 5, the second motor 15, the elevation device 17, the rotating device 18, the actuator 19, etc. to control motion of the robot 1.

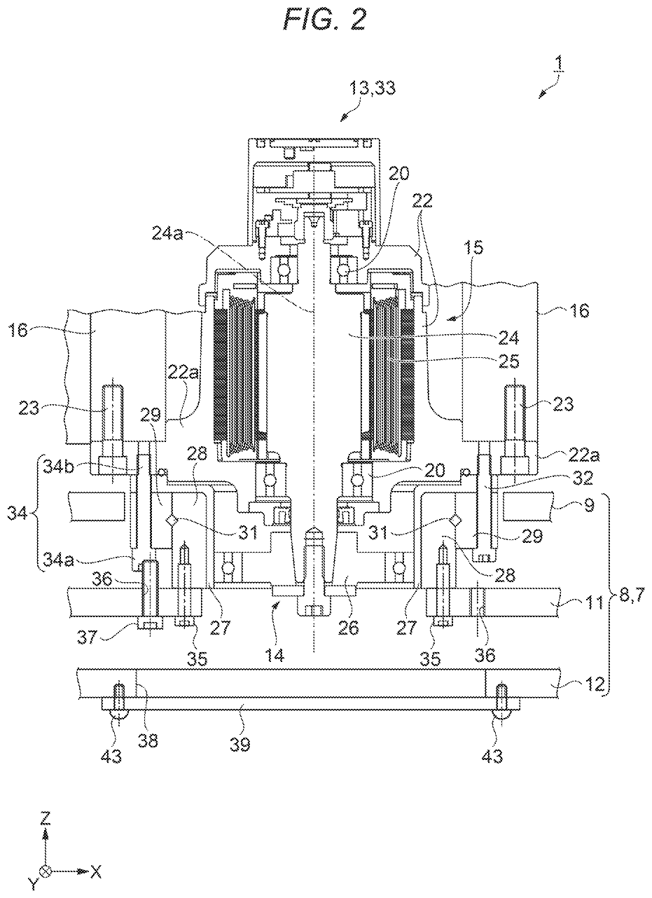

As shown in FIG. 2, the second motor 15 includes a case 22. The case 22 has a flange 22a. The flange 22a of the case 22 is fixed to the second arm 16 by first bolts 23. A rotor 24 and a stator 25 are placed inside of the case 22. The rotor 24 is rotatably supported by a first bearing 20. The rotor 24 rotates around a rotation shaft 24a as a rotation center.

The second reducer 14 includes a wave generator 26 as a wave generator, a flexspline 27 as an external gear, and an inner ring portion 28 and an outer ring portion 29 as an internal gear. Therefore, the joint unit 13 has the inner ring portion 28 and the outer ring portion 29. The wave generator 26 is fixed to the rotor 24 and rotates in synchronization with the rotor 24. The wave generator 26 has an elliptical shape as seen from the axial direction of the rotor 24. The flexspline 27 is placed between the wave generator 26 and the inner ring portion 28. The flexspline 27 is the external gear with teeth formed at the inner ring portion 28 side. The inner ring portion 28 is the internal gear with teeth formed at the flexspline 27 side.

The second reducer 14 has the inner ring portion 28 as the internal gear and the flexspline 27 as the external gear having flexibility. The flexspline 27 partially meshes with the inner ring portion 28 and rotates around the rotation shaft 24a relative to the inner ring portion 28. The wave generator 26 is provided inside of the flexspline 27 and moves a mesh position in a circumferential direction around the rotation shaft 24a. The inner ring portion 28 is coupled to the internal gear and integrated.

In a location on the long axis of the elliptical shape in the wave generator 26, the teeth of the flexspline 27 and the teeth of the inner ring portion 28 mesh each other. In a location on the short axis of the elliptical shape in the wave generator 26, the teeth of the flexspline 27 and the teeth of the inner ring portion 28 are separated. The number of teeth of the inner ring portion 28 is larger than the number of teeth of the flexspline 27 by two. When the wave generator 26 rotates one revolution, the flexspline 27 and the inner ring portion 28 relatively rotate by the two teeth.

A cylindrical roller 31 is placed between the inner ring portion 28 and the outer ring portion 29, and the inner ring portion 28 and the outer ring portion 29 function as bearings. The joint unit 13 includes the inner ring portion 28 rotating coaxially with the outer ring portion 29. Ends of the outer ring portion 29 and the flexspline 27 are fixed to the flange 22a of the case 22 by a plurality of second bolts 32. As described above, the joint unit 13 includes the second motor 15 having the second reducer 14. The outer ring portion 29 is fixed to the second arm 16 via the case 22 of the second motor 15.

When the rotor 24 rotates, the inner ring portion 28 rotates relative to the case 22. Therefore, the inner ring portion 28 serves as the output shaft of the second reducer 14. According to the configuration, the case 22 of the second motor 15 is detached from the second arm 16, and thereby, the outer ring portion 29 is detached from the second arm 16. Therefore, the joint unit 13 may be easily detached from the second arm 16.

The second reducer 14 and the second motor 15 integrally form a motor unit 33. According to the configuration, the second reducer 14 and the second motor 15 are integrated as the motor unit 33. Therefore, the motor unit 33 may be easily detached from the second arm 16.

A second stopper 34 is provided in the outer ring portion 29. The second stopper 34 includes a head portion 34a and a screw portion 34b. The second stopper 34 fixes the ends of the outer ring portion 29 and the flexspline 27 to the flange 22a of the case 22 like the second bolts 32. The second stopper 34 rotates around the rotation shaft 24a as the rotation center.

The inner ring portion 28 is fixed to the middle plate 11 of the first arm 7 by third bolts 35. When the inner ring portion 28 rotates relative to the outer ring portion 29, the second arm 16 rotates relative to the first arm 7.

A plurality of first opening portions 36 are provided in the middle plate 11 of the housing 8. The first opening portions 36 are placed in locations facing the outer ring portion 29 and open toward the outer ring portion 29. Female threads are formed in the first opening portions 36. First stoppers 37 are provided in the first opening portions 36. Therefore, the first stoppers 37 are placed in the first opening portions 36 of the middle plate 11. According to the configuration, the housing 8 includes the middle plate 11 inside, and thereby, rigidity in the horizontal direction rises. Therefore, the first arm 7 may be made harder to bend. Further, the second stopper 34 and the first stoppers 37 are inside of the housing 8, and the housing 8 may have a structure in which the second stopper 34 and the first stoppers 37 do not tangle wires coupled to the second motor 15.

The first stoppers 37 are placed at the opposite side to the joint unit 13 with respect to the first arm 7. That is, the first stoppers 37 are placed at the negative side in the Z direction of the first arm 7. According to the configuration, the first stoppers 37 are placed at the opposite side to the joint unit 13, and thereby, the positions of the first stoppers 37 may be adjusted without detachment of the joint unit 13.

The surface of the outer ring portion 29 at the negative side in the Z direction and the middle plate 11 are apart. Accordingly, there is a space outside of the inner ring portion 28. Further, the second stopper 34 is placed outside of the inner ring portion 28. According to the configuration, the second stopper 34 is placed outside of the inner ring portion 28. The second stopper 34 is placed in the space outside of the inner ring portion 28, and thereby, the volume occupied by the joint unit 13 and the second stopper 34 may be made smaller.

A lower surface opening portion 38 as a second opening portion is provided in a location of the lower plate facing the second reducer 14. The first arm 7 has the lower surface opening portion 38 at the end of the housing 8 at the joint unit 13 side and has a cover 39 covering the lower surface opening portion 38. The cover 39 is fixed to the lower plate 12 by fixing screws 43. The cover 39 is easily detachable. For maintenance of the first stoppers 37, the cover 39 and the window portion 10 may be detached. The cover 39 is transparent and the operator may see the first stoppers 37 through the cover 39. For maintenance of the first stoppers 37, the window portion 10 may be detached and the first stoppers 37 may be operated from the window portion 10 side.

According to the configuration, the lower surface opening portion 38 of the housing 8 is covered by the cover 39. Entry of grit and dust into the housing 8 may be suppressed by the cover 39. The cover 39 is detached, and thereby, the positions of the first stoppers 37 may be easily adjusted.

According to the configuration, the window portion 10 as the part of the housing 8 is transparent and the inside of the housing 8 can be observed. Therefore, the positions of the first stoppers 37 may be adjusted while the first stoppers 37 are observed.

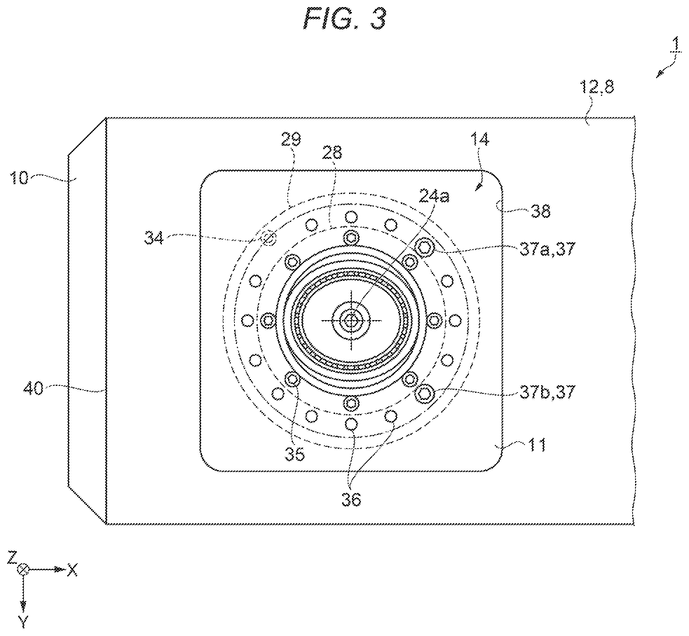

FIGS. 3 to 5 show the second reducer 14 as seen from the lower surface opening portion 38 side. The cover 39 is detached. As shown in FIG. 3, the middle plate 11 has the plurality of first opening portions 36 in which the first stoppers 37 are placed. The plurality of first opening portions 36 are placed on a concentric circle.

According to the configuration, the plurality of first opening portions 36 are provided, and thereby, the locations where the first stoppers 37 are placed may be freely selected.

The first stoppers 37 include a right-side first stopper 37a and a left-side first stopper 37b. The second stopper 34 moves while rotating around the rotation shaft 24a between the right-side first stopper 37a and the left-side first stopper 37b.

The first arm 7 has a side surface opening portion 40 as a second opening portion at the end of the housing 8 at the joint unit 13 side and the window portion 10 covering the side surface opening portion 40.

According to the configuration, the side surface opening portion 40 of the housing 8 is covered by the window portion 10. Entry of grit and dust into the housing 8 may be suppressed by the window portion 10. The window portion 10 is detached, and thereby, the positions of the first stoppers 37 may be easily adjusted.

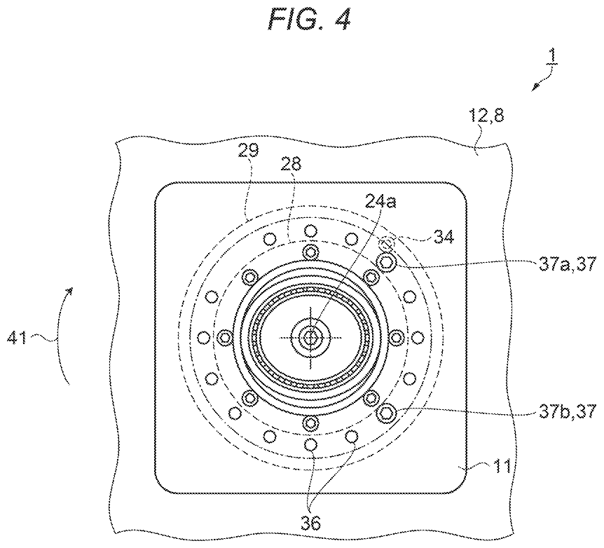

As shown in FIG. 4, the outer ring portion 29 and the second stopper 34 rotate in a right-rotation direction 41 relative to the inner ring portion 28. Here, the second stopper 34 may move until the second stopper interferes with the right-side first stopper 37a.

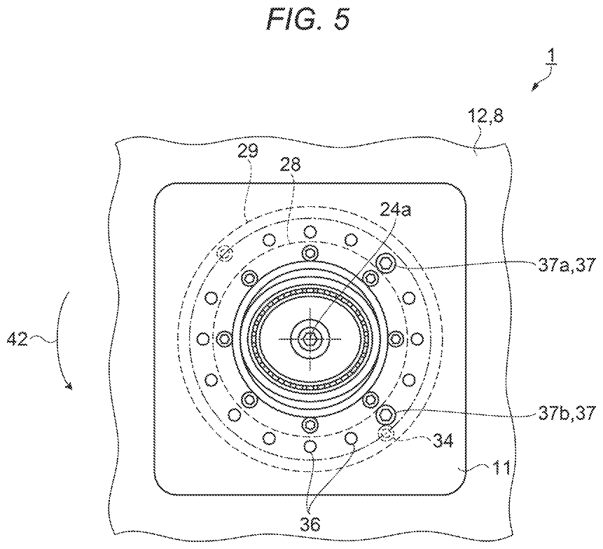

As shown in FIG. 5, the outer ring portion 29 and the second stopper 34 rotate in a left-rotation direction 42 relative to the inner ring portion 28. Here, the second stopper 34 may move until the second stopper interferes with the left-side first stopper 37b.

The second stopper 34 restricts the relative rotation of the second arm 16 to the first arm 7 in cooperation with the first stoppers 37. Further, the first stoppers 37 project from the first opening portions 36 toward the negative side in the Z direction.

According to the configuration, the first arm 7 and the second arm 16 are coupled by the joint unit 13. The first stoppers 37 and the second stopper 34 restrict the relative rotation of the second arm 16 to the first arm 7. When the restricted range is changed, the positions of the first stoppers 37 are changed. The first stoppers 37 project from the first opening portions 36, and thereby, the positions of the first stoppers 37 may be easily changed.

The robot 1 includes the robot arm 1a. According to the configuration, the robot 1 includes the robot arm 1a. In the robot arm 1a, the positions of the first stoppers 37 may be easily changed. Therefore, the robot 1 may be a robot including the robot arm 1a in which the motion range of the second arm 16 can be easily changed.

### Second Embodiment

The embodiment is different from the first embodiment in that the first stoppers 37 have buffer portions. Note that the same configurations as those of the first embodiment have the same signs and the overlapping description will be omitted.

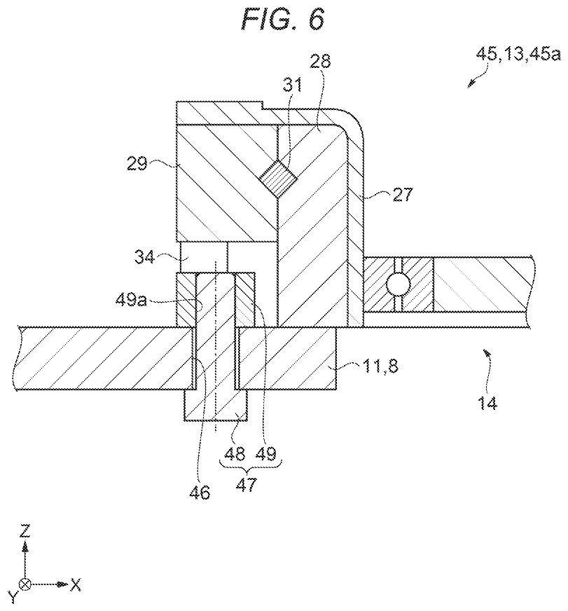

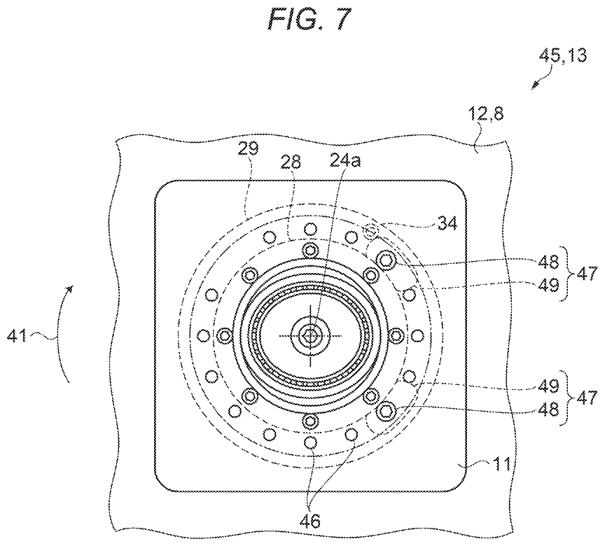

As shown in FIGS. 6 and 7, a robot arm 45a of a robot 45 has the middle plate 11 in the housing 8. First opening portions 46 corresponding to the first opening portions 36 are placed in the middle plate 11. The first opening portions 46 are through holes without threads. First stoppers 47 are placed in the first opening portions 46.

The first stopper 47 includes a fourth bolt 48 and a buffer portion 49. A female thread 49a is formed in the buffer portion 49. The fourth bolt 48 is screwed through the first opening portion 46 into the female thread 49a of the buffer portion 49. Then, the first stoppers 47 are fixed to the middle plate 11. As described above, the first stoppers 47 have the buffer portions 49.

When the second stopper 34 rotates in the right-rotation direction 41 over a specified movement range, the second stopper 34 collides with the first stopper 47. The material of the second stopper 34 is iron and steel and the material of the buffer portion 49 is aluminum. The buffer portion 49 is softer and easier to deform than the second stopper 34. According to the configuration, the buffer portion 49 absorbs shock, and thereby, shock transmission from the second stopper 34 and the first stopper 47 to the second reducer 14 may be suppressed.

When the second stopper 34 rotates in the left-rotation direction 42 over a specified movement range, the second stopper 34 collides with the first stopper 47. Therefore, shock transmission from the second stopper 34 and the first stopper 47 to the second reducer 14 may be suppressed.

### Third Embodiment

The embodiment is different from the first embodiment in that the case 22 of the second motor 15 does not have the flange 22a. Note that the same configurations as those of the first embodiment have the same signs and the overlapping description will be omitted.

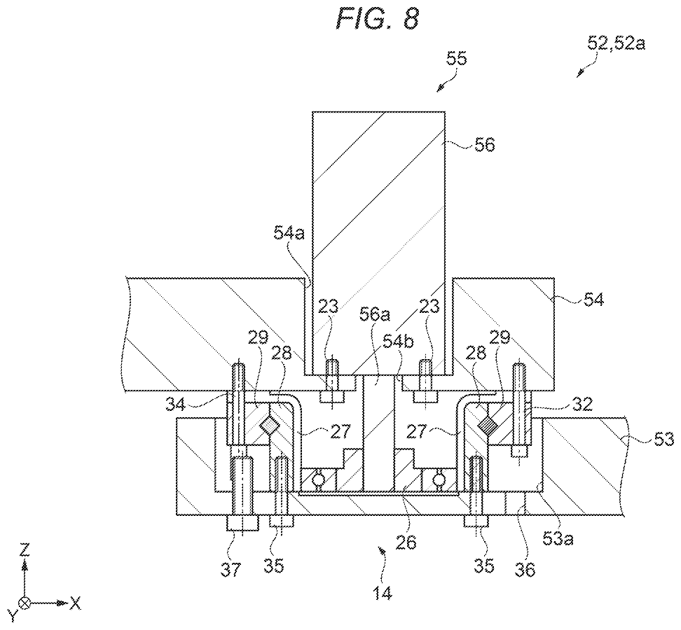

As shown in FIG. 8, a robot arm 52a of a robot 52 has a first arm 53 and a second arm 54. The first arm 53 and the second arm 54 are rotatably coupled by a joint unit 55. The joint unit 55 includes a second motor 56 and the second reducer 14.

The second arm 54 has a second recessed portion 54a and a second through hole 54b in the bottom surface of the second recessed portion 54a. An output shaft 56a of the second motor 56 is inserted into the second through hole 54b. The second motor 56 is fixed to the bottom surface of the second recessed portion 54a by the first bolts 23.

The output shaft 56a is fixed to the wave generator 26. The flexspline 27 and the outer ring portion 29 are fixed to the second arm 54 by the second bolts 32. The second stopper 34 is fixed to the second arm 54.

The first arm 53 has a first recessed portion 53a. The inner ring portion 28 is fixed to the bottom surface of the first recessed portion 53a by the third bolts 35. The first opening portions 36 are placed along a circle around the output shaft 56a in the bottom surface of the first recessed portion 53a. The first stoppers 37 are fastened by screws into the two first opening portions 36.

As described above, the outer ring portion 29 is fixed to the second arm 54. According to the configuration, the number of parts intervening between the outer ring portion 29 and the second arm 54 may be reduced.

### Fourth Embodiment

The embodiment is different from the first embodiment in that the first recessed portion 53a is formed in the first arm 53 and the inner ring portion 28 is fixed to the bottom surface of the first recessed portion 53a. The embodiment is different from the third embodiment in that the second motor 15 having the flange 22a is placed. Note that the same configurations as those of the first embodiment and the third embodiment have the same signs and the overlapping description will be omitted.

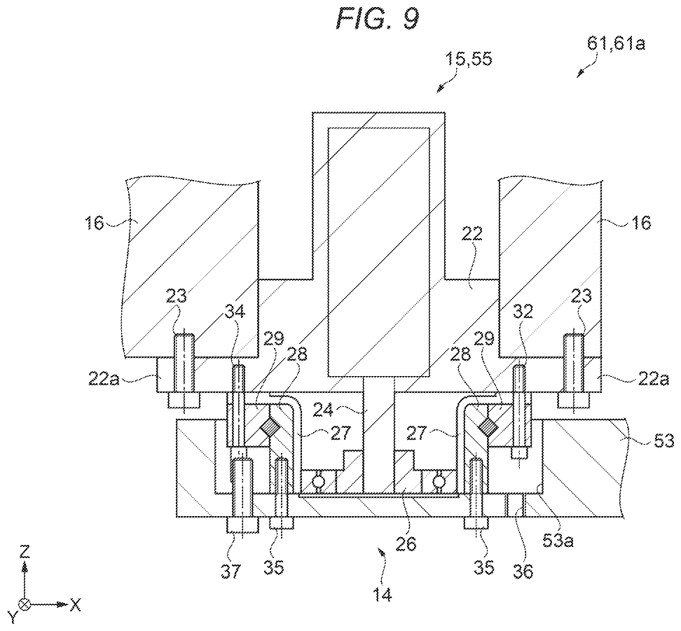

As shown in FIG. 9, a robot arm 61a of a robot 61 has the first arm 53 and the second arm 16. The first arm 53 and the second arm 16 are rotatably coupled by the joint unit 55. The joint unit 55 includes the second motor 15 and the second reducer 14.

The flange 22a of the case 22 is fixed to the second arm 16 by the first bolts 23. The rotor 24 of the second motor 15 is fixed to the wave generator 26. The flexspline 27 and the outer ring portion 29 are fixed to the flange 22a by the second bolts 32. Also, the second stopper 34 is fixed to the flange 22a.

The first arm 53 has the first recessed portion 53a. The inner ring portion 28 is fixed to the bottom surface of the first recessed portion 53a by the third bolts 35. The first opening portions 36 are placed along a circle around the rotor 24 in the bottom surface of the first recessed portion 53a. The first stoppers 37 are fastened by screws into the two first opening portions 36.

In the structure, the first stoppers 37 are exposed from the first arm 53, and thereby, the positions of the first stoppers 37 may be easily changed.

### Fifth Embodiment

In the first embodiment, the robot 1 including the joint unit 13 between the first arm 7 and the second arm 16 is explained. Or, a structure in which a joint between the support 3 as the first member and the first arm 7 as the second member has the second stopper 34 and the first stoppers 37 like the joint unit 13 may be employed.

Or, a structure in which the second arm 16 is coupled to the support 3 and the actuator 19 is placed in the first arm 7 may be employed. The second motor 15 may be fixed to the arm at the support 3 side and the output of the second reducer 14 may be fixed to the arm at the actuator 19 side.

Or, when the robot includes the second arm and the third arm, a structure in which a joint between the second arm as the first member and the third arm as the second member has the second stopper 34 and the first stoppers 37 like the joint unit 13 may be employed.

### Sixth Embodiment

In the first embodiment, the horizontal articulated robot is explained, however, the number of joints of the robot is arbitrary and the embodiment can be applied to a vertical articulated robot.

Further, the placement of the second stopper 34 and the first stoppers 37 according to the present disclosure may be incorporated in various apparatuses each having a configuration that transmits drive power from one side to the other side of a first member and a second member pivoting relative to each other.

What is claimed is:

1. A robot arm comprising:
a first member having a housing with a first stopper provided therein;
a second member rotating relative to the first member; and
a joint unit including an outer ring portion fixed to the second member, a second stopper provided in the outer ring portion and restricting rotation of the second member relative to the first member in cooperation with the first stopper, and an inner ring portion fixed to the first member and rotating coaxially with the outer ring portion, wherein
the housing has a first opening portion opening toward the outer ring portion in a position facing the outer ring portion, and
the first stopper projects from the first opening portion.

2. The robot arm according to claim 1, wherein
the housing has a middle plate inside and the first stopper is placed in the first opening portion in the middle plate.

3. The robot arm according to claim 1, wherein
the joint unit includes a motor having a reducer, the outer ring portion is fixed to the second member via a case of the motor, and the inner ring portion serves as an output shaft of the reducer.

4. The robot arm according to claim 3, wherein
the reducer and the motor are integrated to form a motor unit.

5. The robot arm according to claim 4, wherein
the reducer is a wave gearing.

6. The robot arm according to claim 5, wherein
the wave gearing has an internal gear, an external gear partially meshing with the internal gear, rotating around a rotation shaft relative to the internal gear, and having flexibility, and a wave generator provided inside of the external gear and moving a mesh position in a circumferential direction around the rotation shaft, and the inner ring portion is coupled to the internal gear and the second stopper is placed outside of the inner ring portion.

7. The robot arm according to claim 1, wherein
the first stopper is placed at an opposite side to the joint unit with respect to the first member.

8. The robot arm according to claim 7, wherein
a plurality of the first opening portions with the first stoppers placed therein are provided.

9. The robot arm according to claim 1, further comprising a second opening portion at an end of the housing and a cover covering the second opening portion.

10. The robot arm according to claim 9, wherein
a part of the housing is transparent.

11. The robot arm according to claim 1, wherein
the first stopper includes a buffer portion.

12. The robot arm according to claim 1, wherein
the outer ring portion is fixed to the second member.

13. A robot comprising the robot arm according to claim 1.
